(19) United States
(12) Patent Application Publication
(10) Pub. No.: US 2016/0210070 A1
(43) Pub. Date: Jul. 21, 2016

(54) INFORMATION PROCESSING APPARATUS AND FLASH MEMORY CONTROL METHOD

(71) Applicant: Renesas Electronics Corporation, Tokyo (JP)

(72) Inventors: Takashi KURAFUJI, Tokyo (JP); Akira AWATANI, Tokyo (JP)

(21) Appl. No.: 14/990,668

(22) Filed: Jan. 7, 2016

(30) Foreign Application Priority Data
Jan. 16, 2015 (JP) 2015-006688

(51) Int. Cl. G06F 3/06

(52) U.S. Cl. CPC G06F 3/0622; G06F 3/0637; G06F 3/0679

(57) ABSTRACT

An information processing apparatus according to the present invention includes: at least one flash memory including a data storage region that stores data and an erase count storage region that stores erase count data indicating the number of times that the data is erased in the data storage region; and a control circuit that is connected between a processor and the at least one flash memory. The control circuit allows changes of data stored in the data storage region by the processor and suppresses changes of the erase count data stored in the erase count storage region by the processor.

### CROSS-REFERENCE TO RELATED APPLICATIONS

This application is based upon and claims the benefit of priority from Japanese patent application No. 2015-006688, filed on Jan. 16, 2015, the disclosure of which is incorporated herein in its entirety by reference.

### BACKGROUND

The present invention relates to an information processing apparatus and a flash memory control method, and relates to, for example, a technique for recording the number of times that data in the flash memory is erased.

Japanese Unexamined Patent Application Publication No. 2001-312891 discloses a semiconductor memory device including a block erase type flash memory formed of a plurality of memory blocks. The memory block is a minimum erasure unit. The memory block includes a write status writing area including an erasure counter writing area. The number of times that the memory block has been erased is written in the erasure counter writing area. The semiconductor memory device compares the number of erasures written in the erasure counter writing area of each memory block to write data in the memory block that has been erased the fewest number of times.

Further, Japanese Unexamined Patent Application Publication No. 2008-186295 discloses a data recording system including a flash memory. The flash memory stores write count data indicating the number of times that data has been written in the flash memory. When the value of the write count data exceeds a threshold, a CPU of the data recording system outputs an alarm signal.

### SUMMARY

In the techniques disclosed in Japanese Unexamined Patent Application Publication Nos. 2001-312891 and 2008-186295, data (write count data) in the erasure counter writing area is not protected, which causes a problem that a malicious third party can easily tamper with the data (write count data) in the erasure counter writing area.

The other problems of the prior art and the novel characteristics of the present invention will be made apparent from the descriptions of the specification and the accompanying drawings.

According to one embodiment of the present invention, an information processing apparatus allows changes of data stored in a data storage region by a processor and suppresses changes of erase count data indicating the number of times that the data in the data storage region is erased by the processor.

According to the embodiment, it is possible to prevent tampering with data that stores the number of times that data in the flash memory is erased.

### BRIEF DESCRIPTION OF THE DRAWINGS

The above and other aspects, advantages and features will be more apparent from the following description of certain embodiments taken in conjunction with the accompanying drawings, in which:

FIG. 1 is a diagram showing a configuration of a microcontroller according to a first embodiment;

FIG. 2 is a diagram showing a configuration of a flash sequencer according to the first embodiment;

FIG. 3 is a diagram showing configurations of a data storing flash memory and a management status flash memory according to the first embodiment;

FIG. 4 is a diagram showing commands of a flash sequencer according to the first embodiment;

FIG. 5 is a flowchart of data erasure processing of the flash sequencer according to the first embodiment;

FIG. 6 is a state transition diagram of the management status flash memory according to the first embodiment;

FIG. 7 is a diagram showing a configuration of a management status flash memory according to a second embodiment;

FIG. 8 is a flowchart of data erasure processing of a flash sequencer according to the second embodiment;

FIG. 9 is a diagram showing configurations of a data storing flash memory and a management status flash memory according to a third embodiment;

FIG. 10 is a flowchart of data erasure processing of a flash sequencer according to the third embodiment;

FIG. 11 is a diagram showing commands of the flash sequencer according to the third embodiment;

FIG. 12 is a flowchart of count permission configuration processing of the flash sequencer according to the third embodiment;

FIG. 13 is a flowchart of count permission configuration processing of the flash sequencer according to a varied example of the third embodiment;

FIG. 14 is a diagram showing configurations of a data storing flash memory and a management status flash memory according to a fourth embodiment;

FIG. 15 is a flowchart of data erasure processing (former part) of a flash sequencer according to the fourth embodiment;

FIG. 16 is a flowchart of data erasure processing (latter part) of the flash sequencer according to the fourth embodiment;

FIG. 17 is a diagram showing commands of the flash sequencer according to the fourth embodiment; and

FIG. 18 is a flowchart of count upper-limit value configuration processing of the flash sequencer according to the fourth embodiment.

### DETAILED DESCRIPTION

Hereinafter, with reference to the drawings, preferable embodiments will be described. The specific numerical values and the like shown in the following embodiments are merely examples to facilitate understanding of the embodiments and are not limited thereto unless otherwise specified. Further, in the following description and the drawings, for the sake of clarification of the description, matters obvious for those skilled in the art and the like will be omitted or simplified as appropriate.

### First Embodiment

### Configuration of First Embodiment

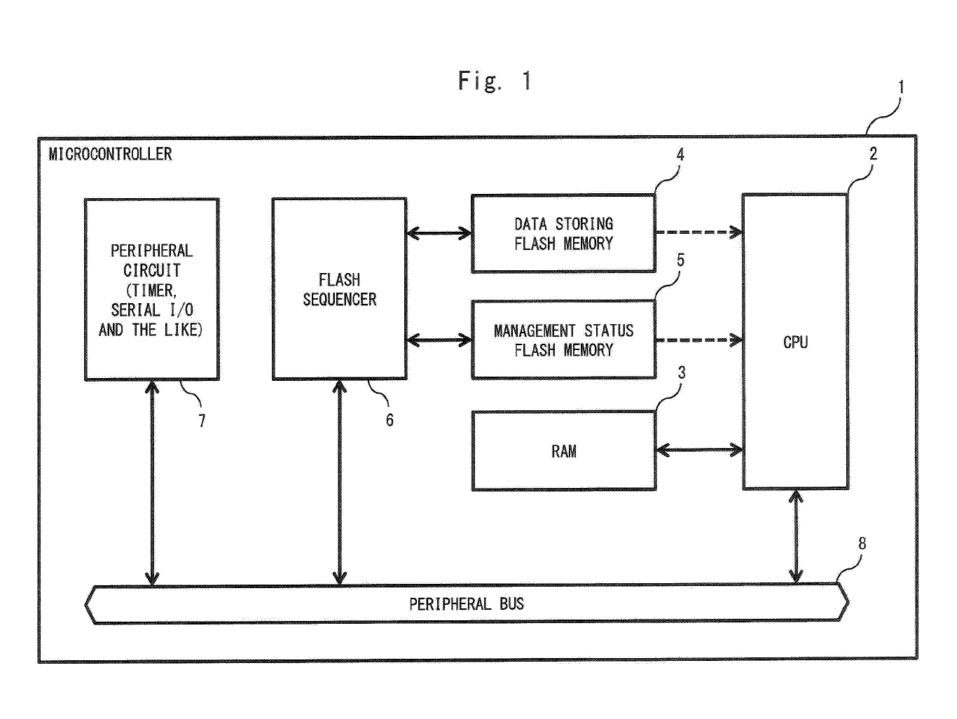

To begin with, a first embodiment of the present invention will be described. With reference to FIG. 1, a configuration of a microcontroller 1 according to the first embodiment will be described. As shown in FIG. 1, the microcontroller 1 includes a Central Processing Unit (CPU) 2, a Random Access Memory (RAM) 3, a data storing flash memory 4, a management status flash memory 5, a flash sequencer 6, and a peripheral circuit 7.

The CPU 2 executes processing based on data stored in the data storing flash memory 4. That is, the data stored in the data storing flash memory 4 includes a program (software) that causes the CPU 2 to execute processing for enabling the function of the microcontroller 1 to be achieved. The CPU 2 may first load the program stored in the data storing flash memory 4 into the RAM 3 and then execute the program.

The RAM 3 is a volatile memory that stores data used by the CPU 2. The data stored in the RAM 3 includes data which is being processed when the CPU 2 executes the program, data before an update that is temporarily saved when the data stored in the data storing flash memory 4 is updated and the like. Further, as described above, the RAM 3 may store the program loaded from the data storing flash memory 4.

The data storing flash memory 4 is a non-volatile memory that stores data used by the CPU 2. The management status flash memory 5 is a non-volatile memory that stores data indicating the state of the data storing flash memory 4.

The flash sequencer 6 is a circuit that controls the data storing flash memory 4 and the management status flash memory 5. The flash sequencer 6 is connected between the CPU 2 and each of the data storing flash memory 4 and the management status flash memory 5. In other words, the flash sequencer 6 is configured in such a way that data can be mutually written or read between the flash sequencer 6 and each of the CPU 2, the data storing flash memory 4, and the management status flash memory 5.

According to the above configuration, the CPU 2 cannot write data into the data storing flash memory 4 and the management status flash memory 5 and erase data in the data storing flash memory 4 and the management status flash memory 5 without the intervention of the flash sequencer 6. The readout of the data from the data storing flash memory 4 and the management status flash memory 5 by the CPU 2 may not be executed without the intervention of the flash sequencer 6, similar to the above example in which write and erase operations are performed, or may be directly executed without the intervention of the flash sequencer 6.

The peripheral circuit 7 includes at least one circuit among a timer, a serial I/O and the like. The CPU 2 executes processing using the peripheral circuit 7 as appropriate. The CPU 2, the flash sequencer 6, and the peripheral circuit 7 are connected to a peripheral bus 8.

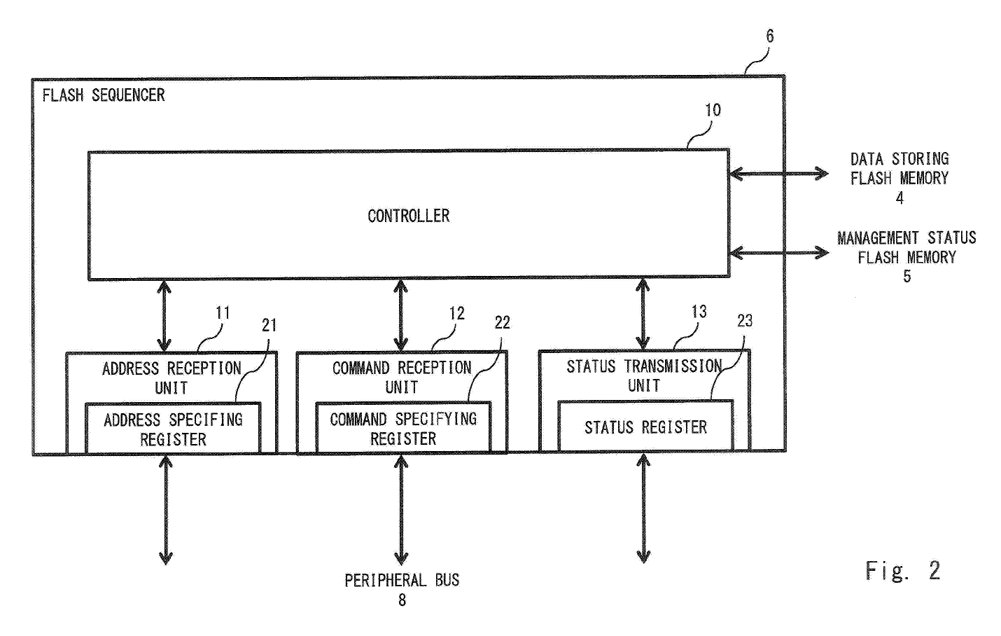

With reference next to FIG. 2, a configuration of the flash sequencer 6 according to the first embodiment will be described. The flash sequencer 6 includes a controller 10, an address reception unit 11, a command reception unit 12, and a status transmission unit 13.

The controller 10 executes control of the data storing flash memory 4 and the management status flash memory 5.

The address reception unit 11 receives address data transmitted from the CPU 2. The address data is data indicating addresses in the data storing flash memory 4 and the management status flash memory 5.

The command reception unit 12 receives write data transmitted from the CPU 2. The write data is data from the CPU 2 written into the flash sequencer 6 to specify control contents executed by the flash sequencer 6. The control contents specified by the write data include writing of data in the data storing flash memory 4, erasure of the data stored in the data storing flash memory 4 and the like. More specifically, the CPU 2 writes the write data into the flash sequencer 6 in a predetermined order to specify the control contents executed by the flash sequencer 6. The series of write data corresponds to commands that specify the control contents of the flash sequencer 6.

The status transmission unit 13 transmits status data to the CPU 2. The status data is data indicating the control state of the data storing flash memory 4 and the management status flash memory 5 by the flash sequencer 6. The status data includes, for example, a write error, an erase error and the like shown as the control state.

The address reception unit 11 includes an address specifying register 21. The address specifying register 21 is a register in which the address data from the CPU 2 is written. The writing of the address data from the CPU 2 into the address specifying register 21 corresponds to the reception of the address data stated above.

The command reception unit 12 includes a command specifying register 22. The command specifying register 22 is a register in which the write data from the CPU 2 is written. The writing of the write data from the CPU 2 into the command specifying register 22 corresponds to the reception of the write data stated above.

The status transmission unit 13 includes a status register 23. The status register 23 is a register in which the status data from the controller 10 is written. The writing of the data from the controller 10 in the status register 23 corresponds to the transmission of the status data described above. That is, the CPU 2 is able to read out the status data written into the status register 23 via the peripheral bus 8.

The controller 10 executes control corresponding to a series of write data (commands) written in the command specifying register 22 on the address indicated by the address data written into the address specifying register 21 in the data storing flash memory 4.

While the example in which the address specifying register 21 and the command specifying register 22 are separately provided has been described above with reference to FIG. 2, the present invention is not limited to this example. For example, the address specifying register 21 and the command specifying register 22 may be a physically one register. In this case, for example, the write data may be written into this register after the address data is written into the register. Further, the address data and the write data are not limited to being input in parallel (a plurality of bits are concurrently input) to the flash sequencer 6 and may instead be input in serial (bit by bit).

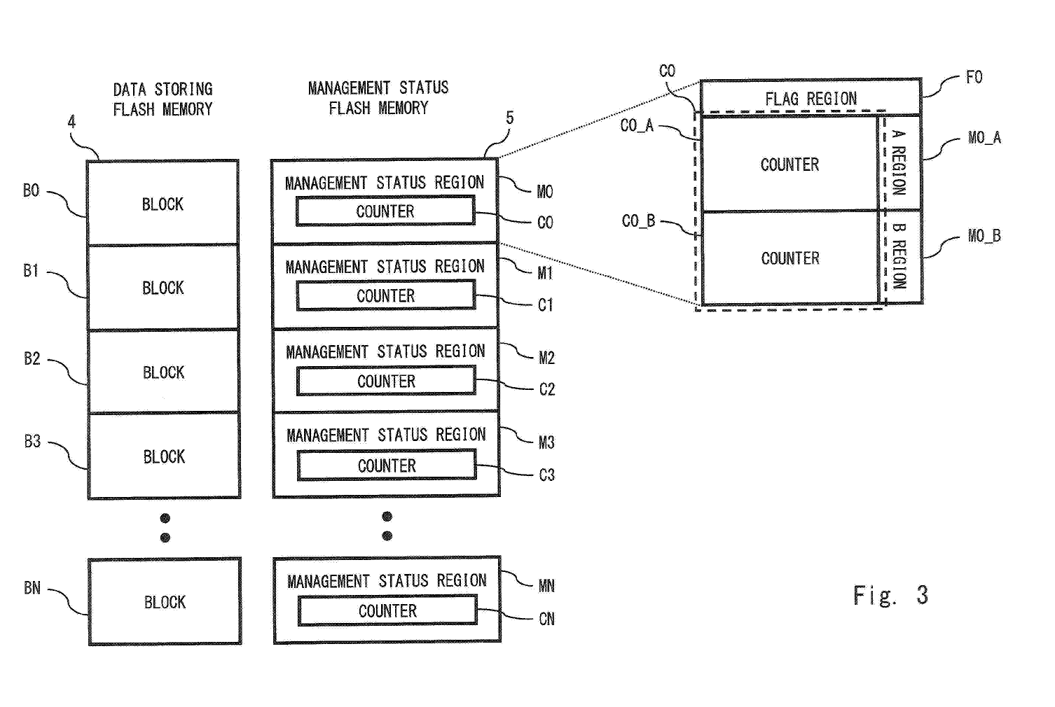

Referring next to FIG. 3, configurations of the data storing flash memory 4 and the management status flash memory 5 according to the first embodiment will be described.

First, the configuration of the data storing flash memory 4 will be described. The data storing flash memory 4 includes a plurality of blocks B0 to BN (N is a predetermined positive integer and the same is true for the following description). In the following description, the blocks B0 to BN will be simply referred to as a “block B” unless a specific block is mentioned.

Each of the blocks B0 to BN corresponds to a minimum unit in which data is erased in the data storing flash memory 4. The blocks B0 to BN typically have the same size. Data can be written in each of the blocks B0 to BN in a size smaller than the size of each of the blocks B0 to BN.

Next, the configuration of the management status flash memory 5 will be described. The management status flash memory 5 includes a plurality of management status regions M0 to MN corresponding to the plurality of blocks B0 to BN, respectively. In other words, the management status storage region Mi corresponds to the block Bi (i may be any integer from 0 to N and the same is true for the following description). The plurality of management status regions M0 to MN include counters C0 to CN, respectively. That is, the management status storage region Mi includes the counter Ci. The management status regions M0 to MN typically have the same size.

The plurality of counters C0 to CN correspond to the plurality of blocks B0 to BN, respectively, and store the count values indicating the number of times that the data is erased in the blocks B0 to BN, respectively. That is, the counter Ci of the management status region Mi stores the count value of the block Bi. The counters C1 to CN typically have the same size.

In the following description, the management status regions M0 to MN will be referred to as a “management status region M” unless a specific region is mentioned. Similarly, the counters C0 to CN will be referred to as a “counter C” unless a specific counter is mentioned.

Each of the management status regions M0 to MN includes a flag region, an A region, and a B region. While only the configuration of the management status region M0 will be representatively shown in FIG. 3, the respective configurations of the management status regions M1 to MN are similar to that of the management status region M0.

A flag region F0 stores a value indicating which one of an A region M0_A and a B region M0_B is valid. In the following description, the one of the A region M0_A and the B region M0_B that is valid is also referred to as a “valid region” and the one of the A region M0_A and the B region M0_B that is not valid is referred to as an “invalid region”. When the value of the flag region F0 is a predetermined value, for example, the A region M0_A is the valid region and the B region M0_B is the invalid region. When the value of the flag region F is a value other than the predetermined value stated above, the A region M0_A is the invalid region and the B region M0_B is the valid region.

The A region M0_A and the B region M0_B include a counter C0_A and a counter C0_B, respectively. That is, the counter C0 includes the counter C0_A and the counter C0_B. Therefore, it can be said that the value stored in the flag region F is a value indicating which one of the count values of the counter C0_A and the counter C0_B is valid. The count value in the A region M0_A and the count value in the B region M0_B are alternately updated.

More specifically, when the A region M0_A is valid, the current count value is stored in the counter C0_A of the A region M0_A. In this case, when the count value is updated, the count value of the counter C0_A is not updated and the value after updating the count value is stored in the counter C0_B as a new current count value. After that, the B region M0_B is made valid. On the other hand, when the B region M0_B is valid, the current count value is stored in the counter C0_B of the B region M0_B. In this case, when the count value is updated, the count value of the counter C0_B is not updated and the value after updating the count value is stored in the counter C0_A as the new current count value. After that, the A region M0_A is made valid.

Each of the flag region F0, the A region M0_A, and the B region M0_B has a size equal to or larger than the minimum unit (block) in which data is erased in the management status flash memory 5. More specifically, typically, the flag region F0, the A region M0_A, and the B region M0_B are each formed of one block and these blocks are different from one another. That is, the flag region F, the A region M0_A, and the B region M0_B typically have the same size. However, when the maximum value of the count value cannot be expressed by the amount of data of one block, each of the A region M0_A and the B region M0_B can be formed of a plurality of blocks. While the value stored in the flag region F0 can be actually expressed by the amount of data of one block, it can be formed of a plurality of blocks. Further, the value stored in the flag region F0, the value stored in the A region M0_A, and the value stored in the B region M0_B are not necessarily expressed using all the bits in the block forming each region. Therefore, the value stored in the flag region F0, the value stored in the A region M0_A, and the value stored in the B region M0_B may be expressed by data having sizes different from one another.

Hereinafter, unless a specific one of the management status regions M0 to MN is mentioned, the flag region will be referred to as a “flag region F”, the A region will be referred to as an “A region M_A”, the B region will be referred to as a “B region M_B”, the counter of the A region will be referred to as a “counter C_A”, and the counter of the B region will be referred to as a “counter C_B”.

As stated above, in the first embodiment, the number of times that the data in the data storing flash memory 4 is erased is managed as a count value in the management status flash memory 5, whereby it is possible to detect tampering with data (e.g., software) in the data storing flash memory 4 by a malicious third party. When the software is tampered with by the malicious third party without authorization, the number of erasing operations managed by the management status flash memory 5 becomes larger than the number of times that the software in the data storing flash memory 4 is normally updated. This is because data needs to be erased once in the flash memory when data is rewritten. Therefore, when an authorized operator updates the software of the data storing flash memory 4, for example, the number of times that the software has been updated is compared to the number of erasing operations managed by the management status flash memory 5, whereby it is possible to detect unauthorized tampering with the software of the data storing flash memory 4 by the malicious third party.

### Operation of First Embodiment

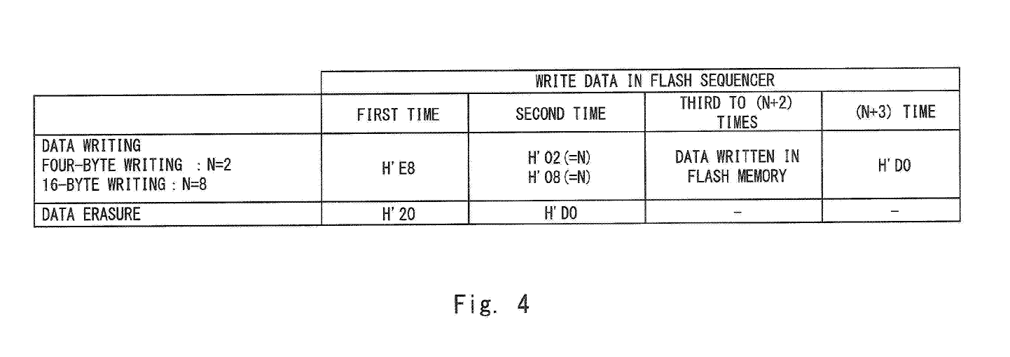

Referring next to FIG. 4, commands of the flash sequencer 6 according to the first embodiment will be described. As shown in FIG. 4, a data write command and a data erasure command are prepared as the commands that control the flash sequencer 6.

When data is written into the data storing flash memory 4, the CPU 2 writes the address data into the address specifying register 21 via the peripheral bus 8 to specify the address in the data storing flash memory 4 in which data is to be written. The CPU 2 sequentially writes the write data indicating the write command into the command specifying register 22. More specifically, when the CPU 2 writes 4-byte data in the data storing flash memory 4, as shown in FIG. 4, the CPU 2 sequentially writes the write data in the command specifying register 22 in the order of H′E8, H′02, 4-byte data (2-byte data twice), and H′D0. Further, when the CPU 2 writes 16-byte data in the data storing flash memory 4, as shown in FIG. 4, the CPU 2 sequentially writes the write data in the command specifying register 22 in the order of H′E8, H′08, 16-byte data (2-byte data eight times), and H′D0. The symbol “H′” indicates that the following numerical value is a hexadecimal number.

In accordance therewith, the controller 10 of the flash sequencer 6 writes the data written into the command specifying register 22 in the address in the data storing flash memory 4 indicated by the address data written into the address specifying register 21. That is, when H′02 is written in the second writing, the controller 10 writes 4-byte data that has been written for the third and the fourth times in the region for four bytes from the address specified by the address data. Further, when H′08 is written in the second writing, the controller 10 writes 16-byte data that has been written for the third to tenth times in the region for 16 bytes from the address specified by the address data.

When the data in the data storing flash memory 4 is erased, the CPU 2 writes the address data into the address specifying register 21 via the peripheral bus 8 to specify the address of the block B in the data storing flash memory 4 where data is to be erased. The CPU 2 then sequentially writes the write data indicating the data erasure command into the command specifying register 22. More specifically, the CPU 2 sequentially writes the write data into the command specifying register 22 in the order of H′20 and H′D0.

In accordance therewith, the controller 10 of the flash sequencer 6 erases the data of the block B of the address in the data storing flash memory 4 indicated by the address data written into the address specifying register 21. When this data is erased, the controller 10 increments the count value of the counter C in the management status region M corresponding to the block B where data is to be erased to update the count value.

The controller 10 automatically calculates the address of the management status region M including the counter C whose count value is to be updated in the management status flash memory 5 from the address of the block B of the data storing flash memory 4 specified by the address specifying register. A first method or a second method described next may be employed or any other arbitrary method may be employed as the method of calculating the address.

In the first method, for example, for all the blocks B0 to BN and the management status regions M0 to MN, a table indicating the address of the block B in association with the address of the management status region M corresponding to the block B is stored in a storage unit included in the flash sequencer 6 in advance. The storage unit includes, for example, a memory that can store the table. The controller 10 may introduce the address of the management status region M in which the count value is to be updated from the address of the block B where data is to be erased based on the table.

In the second method, for example, the address obtained by deleting a predetermined lower address of the address of the block B where data is to be erased (shifting the address to the right by a predetermined number of bits) is determined as the address of the management status region M. That is, the second method may be used when the size of the management status regions M0 to MN is smaller than the size of the blocks B0 to BN. When the size of the blocks B0 to BN is 65536 times larger than the size of the management status regions M0 to MN, for example, the address of the management status regions M0 to MN can be obtained by deleting the lower 16 bits of the address of the block B (shifting the address to the right by 16 bits). When the address obtained by deleting a predetermined lower address of the address of the block B is deviated from the address of the management status regions M0 to MN by a predetermined size, the address of the management status regions M0 to MN can be calculated by adding or subtracting the offset corresponding to the amount of deviation.

When the write command and the data erasure command are issued by a specification of the address of the management status flash memory 5 from the CPU 2, the controller 10 sends back an error to the CPU 2. More specifically, when the address indicated by the address data written into the address specifying register 21 indicates the address of the management status flash memory 5, the controller 10 does not execute data writing and data erasure. In such a case, the controller 10 may further transmit status data that reports the error to the CPU 2 by the status transmission unit 13.

More specifically, the controller 10 stores the status data indicating the error in the status register 23. For example, a specific bit of the status register 23 is defined as the error flag and 1 is stored in this error flag. The error flag indicating the write error and the error flag indicating the erase error may be collectively defined in one bit or may be defined in bits different from each other. This status data is transmitted to the CPU 2 via the peripheral bus 8. Accordingly, when the status data transmitted from the status transmission unit 13 of the flash sequencer 6 indicates the error, the CPU 2 can recognize that data writing or data erasure has not been executed due to the error.

As stated above, by suppressing the write command and the data erasure command by specifying the address of the management status flash memory 5, it is possible to prevent tampering with the number of erasing operations (count value) by the malicious third party. The data writing and the data erasure for all the regions of the management status flash memory 5 may not be treated as the error. For example, the data writing and the data erasure may be treated as the error when the addresses of the flag region F and the counter C (A region M_A and B region M_A) in the management status flash memory 5 are specified and the data writing and the data erasure may be performed when the other regions are specified. This is because it is still possible to prevent tampering with the number of erasing operations (count value).

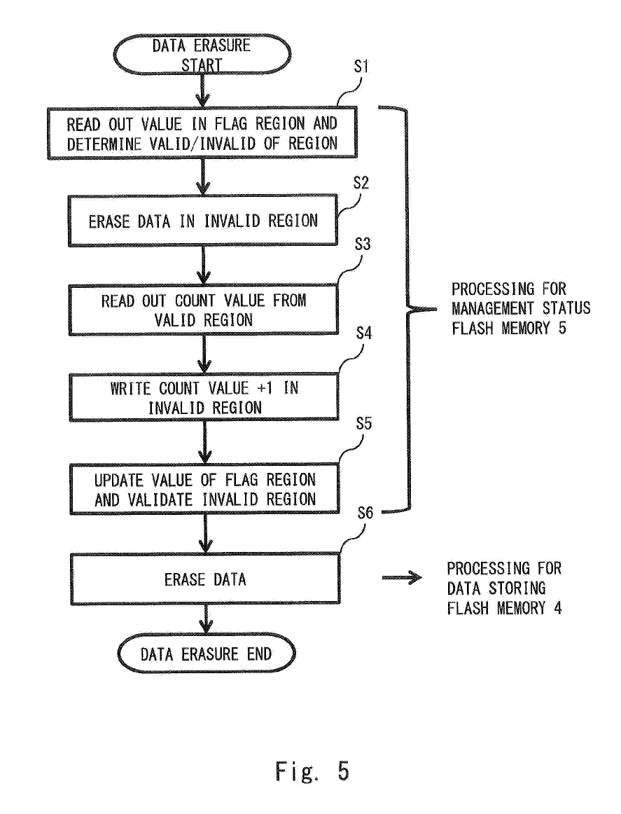

Referring next to FIG. 5, data erasure processing of the flash sequencer 6 according to the first embodiment will be described.

When the write data indicating the data erasure command has been received by the command reception unit 12, the controller 10 of the flash sequencer 6 reads out the value in the flag region F in the management status region M corresponding to the block B where data is to be erased. This block B is a block B positioned in the address indicated by the address data received by the address reception unit 11. The controller 10 determines which one of the A region M_A and the B region M_B is the valid region and which one of them is the invalid region based on the value that has been read out (S1).

The controller 10 erases data in the invalid region and enables a new count value to be written (S2). The controller 10 reads out the current count value stored in the valid region in the management status region M corresponding to the block B where data is to be erased (S3). The controller 10 writes the value obtained by adding 1 to the current count value that has been read out in the invalid region as a new count value (S4). When the writing is completed, the controller 10 updates the value of the flag region F, invalidates the valid region, and validates the invalid region. That is, the controller 10 updates the value of the flag region F to indicate the region where the new count value is stored as the valid region and the other region as the invalid region (S5). After the completion of the control of the management status flash memory 5, the controller 10 erases data of the block B of the address in the data storing flash memory 4 indicated by the address data written into the address specifying register 21 to end the data erasure processing (S6).

### Characteristics and Effects of First Embodiment

As described above, in the first embodiment, the flash sequencer 6 (control circuit) allows the changes of the data stored in the block B (data storage region) by the CPU 2 (processor) and suppresses the changes of the count value (erase count data) stored in the counter C (erase count storage region) by the CPU 2.

According to the above configuration, it is impossible to change the data (write and erase) by directly specifying the counter C of the management status flash memory 5, which prevents the malicious third party from changing an arbitrary count value. In summary, according to the first embodiment, it is possible to prevent tampering with the number of erasures (count value) in the flash memory.

Further, in the first embodiment, the flash sequencer 6 updates the count value before data is erased in the data storing flash memory 4. In other words, the flash sequencer 6 erases the data stored in the block B after the count value stored in the counter C is updated.

According to the above configuration, even when the malicious third party interrupts the data erasure processing of the flash sequencer 6 by means of resetting the microcontroller 1 or turning off/on the power supply thereof, the count value is updated before the actual data erasure, which prevents the malicious third party from altering the count value to an inappropriate count value that is smaller than the actual number of erasures. It is therefore possible to prevent the malicious third party from altering the count value to a smaller value to hide unauthorized tampering with data in the data storing flash memory 4.

Further, in the first embodiment, as shown in FIG. 5, when the data in the block B is erased, the count value is acquired from one of the A region M_A and the B region M_B which is indicated as valid by the value of the flag region F (region information), the count value acquired is updated and stored in the other region, and the value of the flag region F is updated to indicate the other region as valid. According to the above configuration, even when the malicious third party interrupts data erasure processing of the flash sequencer 6 by means of resetting the microcontroller 1 or turning off/on the power supply thereof, the malicious third party cannot alter the count value to an inappropriate count value that is smaller than the actual number of erasures.

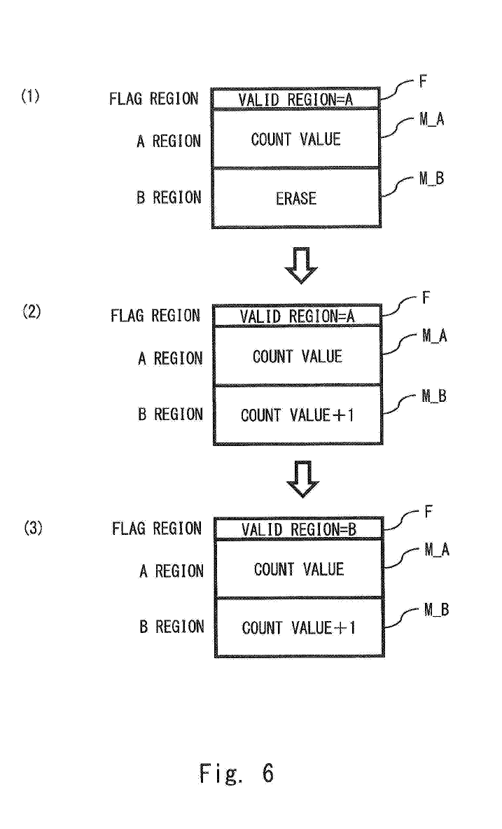

For example, according to the above processing, the value of the flag region F, the count value of the A region M_A, and the count value of the B region M_B transition through the states of (1) to (3) shown in FIG. 6. FIG. 6 shows an example in which processing has been started from the state in which the A region M_A is valid.

The state shown in (1) shows a state in which the count value in the invalid region has been erased (S2 in FIG. 5). The state shown in (2) shows a state in which the value obtained by adding 1 to the current count value is written in the invalid region as a new count value (S4 in FIG. 5). The state shown in (3) shows a state in which the value of the flag region F has been updated to indicate the region that stores the new count value as the valid region (S5 in FIG. 5). As described above, after the state shown in (3), the data is actually erased (S6 in FIG. 5).

First, when the processing is interrupted in the state shown in (1), the count value before the update is valid and the data erasure has not yet been performed. Therefore, the count value matches the actual number of erasures. When the processing is interrupted in the state of (2) as well, the count value before the update is valid and the data erasure has not yet been performed. Therefore, in this case as well, the count value matches the actual number of erasures. When the processing is interrupted in the state of (3), while the count value after the update is valid, the data erasure has not yet been performed. Therefore, in this case, the count value is larger than the actual number of erasures.

Therefore, according to the first embodiment, there is no case in which the count value becomes smaller than the actual number of erasures. According to the above configuration, when the data in the data storing flash memory 4 is tampered with without authorization by the malicious third party, the count value becomes definitely larger than the number of times that the data has been normally updated. It is therefore possible to definitely detect that the malicious third party has rewritten the software or the like of the data storing flash memory 4 without authorization.

### Second Embodiment

Next, a second embodiment will be described. The descriptions of the contents similar to those of the first embodiment will be omitted as appropriate. For example, since the configurations of the microcontroller 1, the flash sequencer 6, and the data storing flash memory 4 in the second embodiment are similar to those of the first embodiment described with reference to FIGS. 1 to 3, the descriptions thereof will be omitted.

### Configuration of Second Embodiment

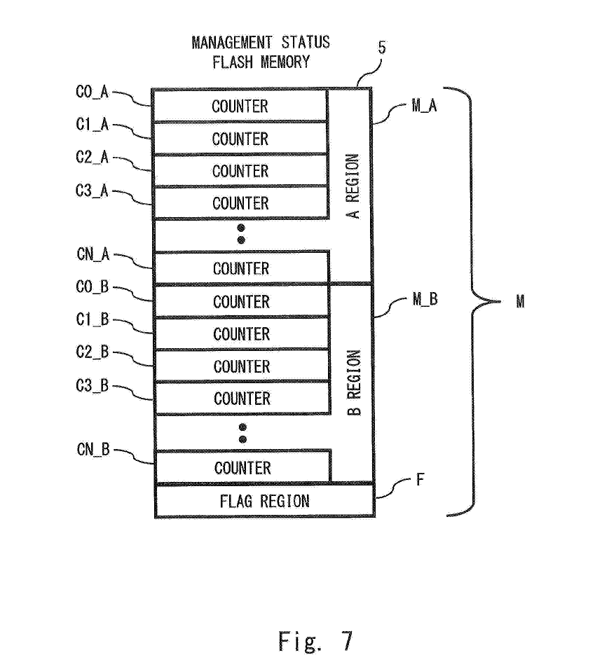

Referring next to FIG. 7, a configuration of the management status flash memory 5 according to the first embodiment will be described.

In the second embodiment, the management status flash memory 5 has only one management status storage region M. That is, as shown in FIG. 7, the management status flash memory 5 includes only one flag region F, only one A region M_A, and only one B region M_B. The A region M_A includes a plurality of counters C0_A to CN_A corresponding to the plurality of blocks B0 to BN, respectively. The B region M_B includes a plurality of counters C0_B to CN_B corresponding to the plurality of blocks B0 to BN, respectively.

As stated above, in the second embodiment, the plurality of counters C0_A to CN_A are collected in one A region M_A and the plurality of counters C0_B to CN_B are collected in one B region M_B. Therefore, it is sufficient that only one flag region F, only one A region M_A, and only one B region M_B (three blocks) are prepared for all the blocks B0 to BN of the data storing flash memory 4. The counters C0_A to CN_A and the counters C0_B to CN_B typically have the same size. That is, the A region M_A and the B region M_B typically have the same configuration.

Similar to the first embodiment, the count value of the A region M_A and the count value of the B region M_B are alternately updated. However, in the flash memory, data needs to be erased before data is written and data is erased in the block unit (A region M_A unit, B region M_B unit), which causes a count value of the counter which should not to be updated to be initialized as well. Therefore, when the count value of the counter is updated, the count value of the counter which should be updated is acquired from the valid region and a count value obtained by incrementing the count value obtained is stored in the invalid region. For the counter which should not be updated, the count value acquired from the valid region is directly stored in the invalid region.

### Operation of Second Embodiment

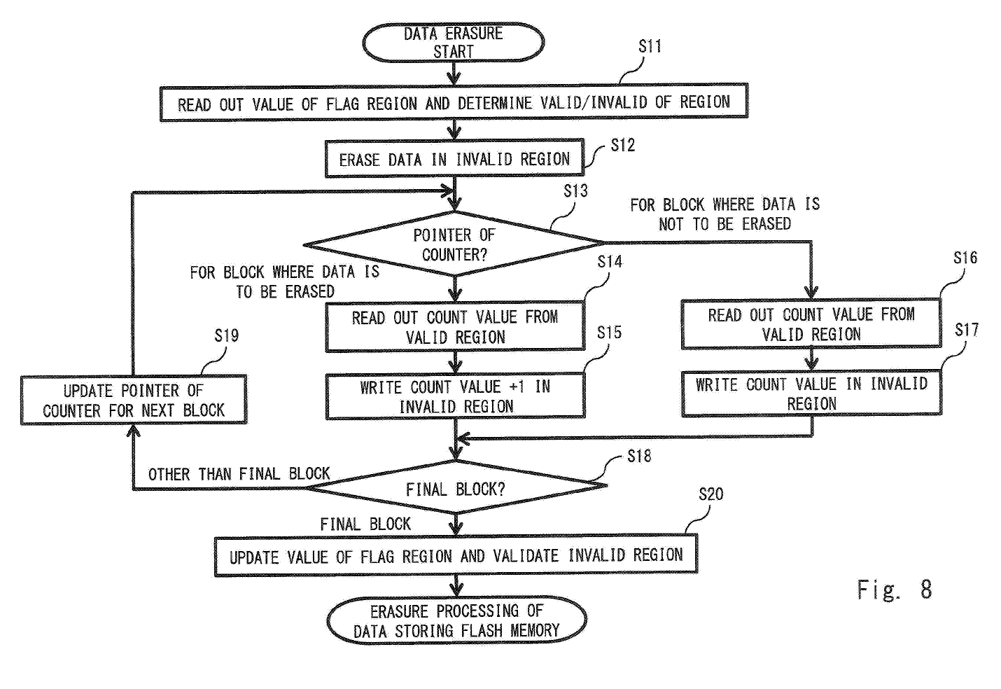

Referring next to FIG. 8, data erasure processing of the flash sequencer 6 according to the second embodiment will be described. While a case in which the A region M_A is valid when data erasure processing is started will be described here, similar processing may be performed in a case in which the B region M_B is valid when data erasure processing is started. When the B region M_B is valid, it is clear that the counters C0_A to CN_A and the counters C0_B to CN_B should be reversed in the following description. Therefore, the description thereof will be omitted.

The controller 10 determines, similar to Steps S1 and S2 in the first embodiment, whether the A region M_A and the B region M_B are valid or invalid and erases data in the invalid region (S11 and S12). That is, the controller 10 determines that the A region M_A is valid (the B region M_B is invalid) and erases the data in the B region M_B, which is the invalid region.

In the second embodiment, the controller 10 manages a pointer indicating the addresses of the counters C_A and C_B that are being processed to enable configurations of the count values of the counters C0_A to CN_A in order. The pointer indicating the addresses of the counters C_A and C_B that are being processed is stored, for example, in the storage unit included in the flash sequencer 6. The pointer indicates the addresses of the counters C0_A and C0_B at the top of the valid region set as an initial value. The pointer may indicate one of the address of the counter C_A of the A region M_A and the address of the counter C_B of the B region M_B. Even in this case, the address of the other counter can be calculated by adding a predetermined offset (e.g., size of the A region M_A) to the address indicated by the pointer or subtracting a predetermined offset (e.g., size of the A region M_A) from the address indicated by the pointer.

The controller 10 determines whether the pointer indicates the counters C_A and C_B corresponding to the block B where data is to be erased (S13). In other words, the controller 10 determines whether the counters C_A and C_B that are being processed are the counters C_A and C_B corresponding to the block B where data is to be erased. An arbitrary method may be used for this determination.

When the determination is made in a similar way as in the first method stated above, for example, for all the blocks B0 to BN and the counters C0_A to CN_A and C0_B to CN_B, a table in which the address of the block B and the addresses of the counters C_A and C_B corresponding to the block B are associated with each other is stored in advance in the storage unit included in the flash sequencer 6. The controller 10 may introduce the addresses of the counters C_A and C_B corresponding to the block B where data is to be erased from the address of the block B where data is to be erased based on the table.

Further, when the determination is made in a similar way as in the second method stated above, for example, it is determined that the pointer indicates the counters C_A and C_B corresponding to the block B when the address obtained by deleting a predetermined lower address of the address of the block B where data is to be erased coincides with the address indicated by the pointer (address of one of the counters C_A and C_B). In other cases, it is determined that the pointer does not indicate the counters C_A and C_B corresponding to the block B. In this case as well, when the address obtained by deleting the lower address of the address of the block B is deviated from the address of the counter C_A or the counter C_B corresponding to the block B by a predetermined size, the address obtained by adding or subtracting the offset corresponding to the amount of deviation may be compared with the address indicated by the pointer.

When it is determined that the pointer indicates the counters C_A and C_B corresponding to the block B where data is to be erased (S13: for the block where data is to be erased), the controller 10 reads out the count value of the counter C_A indicated by the pointer in the A region M_A, which is the valid region (S14). The controller 10 writes the value obtained by adding 1 to the count value that has been read out in the counter C_B indicated by the pointer in the B region M_B, which is the invalid region, as a new count value (S15).

When it is determined that the pointer does not indicate the counters C_A and C_B corresponding to the block B where data is to be erased (S13: for the block where data is not to be erased), the controller 10 reads out the count value of the counter C_A indicated by the pointer in the A region M_A, which is the valid region (S16). The controller 10 directly writes the count value that has been read out in the counter C_B indicated by the pointer in the B region M_B, which is the invalid region, as a new count value (S17).

After the count value has been written into the invalid region (S15 and S17), the controller 10 determines whether the pointer indicates the counters CN_A and C_BN corresponding to the final block BN (S18). In other words, the controller 10 determines whether the counters C_A and C_B that are being processed are counters CN_A and C_BN corresponding to the final block BN.

When the pointer does not indicate the counters CN_A and CN_B corresponding to the final block BN (S18: other than the final block), the controller 10 updates the address indicated by the pointer by the address of the counters CN_A and CN_B corresponding to the next block B (S19), and repeats the processing of updating the counter from S13. In this way, processing is performed in the order of the counters C0_A and C0_B to the counters CN_A and CN_B. When the counters C0_A to CN_A and the counters C0_B to CN_B have the same size and are tightly arranged, for example, the update of the pointer may be performed by advancing the address indicating the pointer by the amount corresponding to the size of the counters C_A and C_B. Further, when the pointer indicates the address of the counters C0_A and C0_B in a format in which the lower bits corresponding to the size of the counters C0_A and C0 Bare omitted, for example, the update of the pointer may be performed by incrementing the address indicated by the pointer by one.

When the pointer indicates the counters CN_A and C_BN corresponding to the final block BN (S18: final block), the controller 10 updates the value of the flag region F, erases the data in the block B, and ends the data erasure processing, similar to Steps S5 and S6 in the first embodiment (S20).

### Characteristics and Effects of Second Embodiment

As described above, in the second embodiment, the controller 10 acquires, for the counters C_A and C_B corresponding to the block B where data is to be erased, the count value from the region indicated as valid by the value of the flag region F (in the example of the second embodiment, A region M_A), updates the count value acquired and stores the updated value in the other region (in the example of the second embodiment, B region M_B). The controller 10 directly stores, for the other counters C_A and C_B, the count value acquired from the region indicated as valid by the value of the flag region F in the other region.

According to the above configuration, it is possible to collectively manage the plurality of count values C0_A to CN_A and the plurality of count values C0_B to CN_B in the A region M_A and the B region M_B, respectively. Therefore, it is sufficient that the management status flash memory 5 has only one flag region F. It is therefore possible to reduce the capacity of the management status flash memory 5 and to construct the mechanism to detect unauthorized tampering with data for a low cost.

Meanwhile, in the second embodiment, compared to the first embodiment, data erasure processing requires update of the count values of all the counters C0_A to CN_A or C0_B to CN_B, whereby processing time by data erasure processing increases. Therefore, when the processing time is prioritized over the capacity of the management status flash memory 5, the configuration of the first embodiment is suitable.

### Third Embodiment

Next, a third embodiment will be described. The descriptions of the contents similar to those of the first embodiment will be omitted as appropriate. For example, since the configurations of the microcontroller 1, the flash sequencer 6, and the data storing flash memory 4 in the third embodiment are similar to those in the first embodiment already described with reference to FIGS. 1 to 3, the descriptions thereof will be omitted.

### Configuration of Third Embodiment

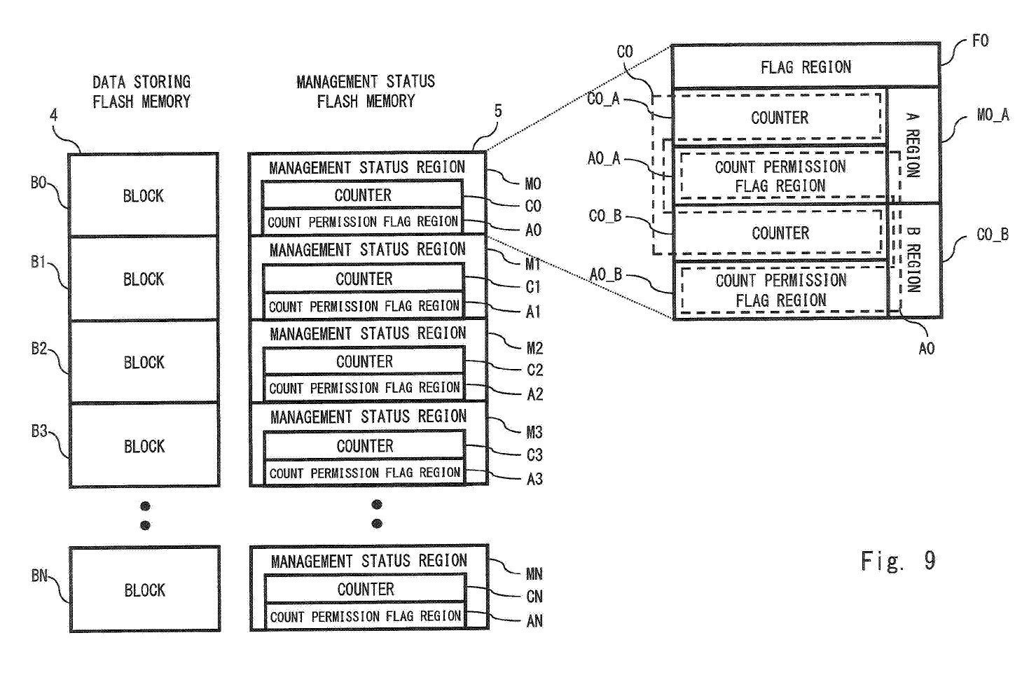

Referring next to FIG. 9, a configuration of the management status flash memory 5 according to the first embodiment will be described.

In the third embodiment, compared to the first embodiment, the management status regions M0 to MN further include a plurality of count permission flag regions A0 to AN, respectively. That is, the management status region Mi includes a count permission flag region Ai. Hereinafter, the count permission flags A0 to A will be referred to as a “count permission flag A” unless a specific count permission flag is mentioned.

The count permission flag regions A0 to AN each store a count permission flag indicating whether it is possible to count the number of erasures by each of the counters C0 to CN. Therefore, when the count permission flag of the count permission flag region Ai indicates count prohibition, the controller 10 does not update the count value of the counter Ci. On the other hand, when the count permission flag of the count permission flag region Ai indicates count permission, the controller 10 updates the count value of the counter Ci. The count permission flag is a flag indicating the count prohibition with the value of “1” and count permission with the value of “0”.

The A region M0_A and the B region M0_B include a count permission flag region A0_A and a count permission flag region A0_B, respectively. That is, the count permission flag region A0 includes the count permission flag region A0_A and the count permission flag region A0_B. Therefore, it can also be said that the value stored in the flag region F is the value indicating which one of the count permission flag region A0_A and the count permission flag region A0_B is valid.

More specifically, when the A region M0_A is valid, the current count permission flag is stored in the count permission flag region A0_A of the A region M0_A. In this case, when the count permission flag is updated, the count permission flag of the count permission flag region A0_A is not updated and the value after the update of the count permission flag is stored in the count permission flag region A0_B as a new current count permission flag. After that, the B region M0_B is made valid. On the other hand, when the B region M0_B is valid, the current count permission flag is stored in the count permission flag region A0_B of the B region M0_B. In this case, when the count permission flag is updated, the count permission flag of the count permission flag region A0_B is not updated and the value after the update of the count permission flag is stored in the count permission flag region A0_A as a new current count permission flag. After that, the A region M0_A is made valid.

Hereinafter, unless a specific one of the management status regions M0 to MN is mentioned, the count permission flag region of the A region will be referred to as a “count permission flag region A_A” and the count permission flag region of the B region will be referred to as a “count permission flag region A_B”.

### Operation of Third Embodiment

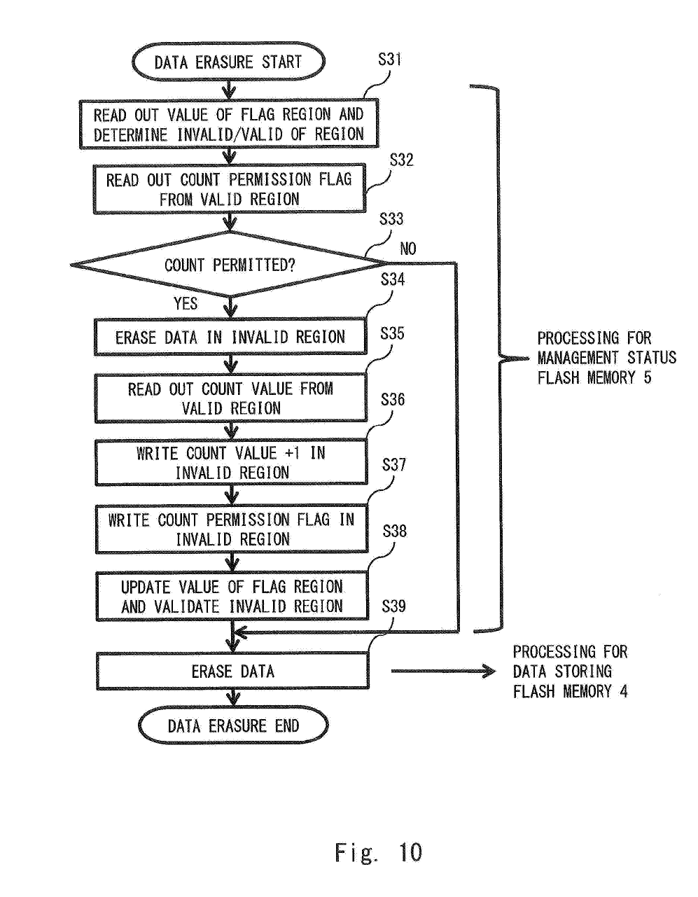

Referring next to FIG. 10, data erasure processing of the flash sequencer 6 according to the third embodiment will be described.

The controller 10 determines, similar to Step S1 in the first embodiment, whether the A region M_A and the B region M_B are valid or invalid (S31). The controller 10 reads out the count permission flag from the count permission flag region A in the valid region in the management status region M corresponding to the block B where data is to be erased (S32). The controller 10 determines whether the count permission flag that has been readout indicates the count permission or the count prohibition (S33).

When the count permission flag that has been read out indicates the count permission (S33: Yes), the controller 10 erases the data in the invalid region, reads out the current count value from the valid region, and writes the value obtained by adding 1 to the current count value that has been read out in the invalid region, similar to Steps S2 to S4 in the first embodiment (S34 to S36). The controller 10 directly writes the count permission flag read out in Step S32 in the count permission flag region A in the invalid region in the management status region M corresponding to the block B where data is to be erased (S37). The controller 10 updates the value of the flag region F, erases the data in the block B, and ends the data erasure processing, similar to Steps S5 and S6 in the first embodiment (S38, S39).

When the count permission flag that has been read out indicates the count prohibition (S33: No), the controller 10 erases the data of the block B and ends the data erasure processing without executing processing of Steps S34 to S38 (S39).

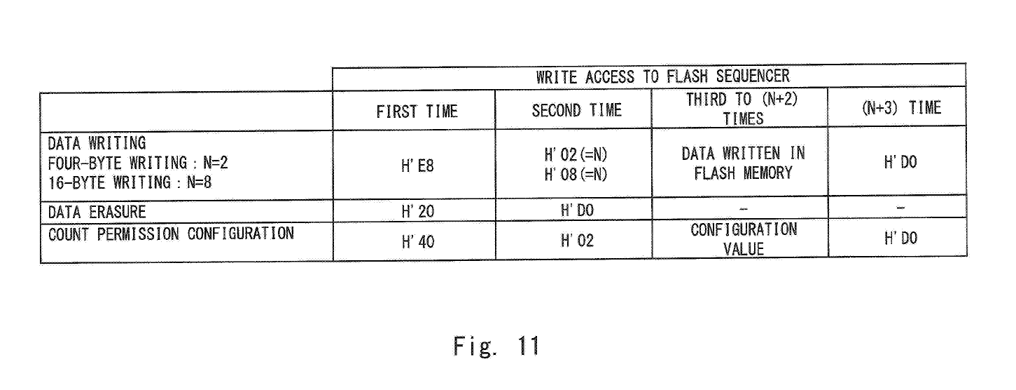

Referring next to FIG. 11, commands of the flash sequencer 6 according to the third embodiment will be described. In the third embodiment, as shown in FIG. 11, a count permission configuration command is further prepared compared to the first embodiment.

When permission of the count of the number of times that the data is erased is configured, the CPU 2 writes the address data in the address specifying register 21 via the peripheral bus 8 to specify the address of the block B in the data storing flash memory 4 where the count of the number of times that the data is erased is permitted. The CPU 2 then sequentially writes the write data indicating the count permission configuration command in the command specifying register 22. More specifically, the CPU 2 sequentially writes the write data in the command specifying register 22 in the order of H′40, H′02, the configuration value for the count permission flag, and H′D0.

In accordance therewith, the controller 10 of the flash sequencer 6 changes the count permission flag of the count permission flag region A of the management status region M corresponding to the block B of the data storing flash memory 4 specified in the address specifying register based on the configuration value written as the write data.

The controller 10 automatically calculates the address of the management status region M including the count permission flag region A where the count permission flag is updated in the management status flash memory 5 from the address of the block B of the data storing flash memory 4 specified in the address specifying register. As a method of calculating the address, the first method or the second method stated above may be employed or any other arbitrary method may be employed.

When the count permission configuration command has been issued by specifying the address of the management status flash memory 5 from the CPU 2, the controller 10 sends back the error to the CPU 2. More specifically, when the address indicated by the address data written into the address specifying register 21 indicates the address of the management status flash memory 5, the controller 10 does not change the count permission flag. Further, in this case, the controller 10 transmits the status data to the CPU 2 by the status transmission unit 13 to notify the CPU 2 of the error. The error flag indicating the count permission configuration error and the error flag indicating the write error and the erase error may be collectively defined in one bit or may be defined in bits different from each other.

While the example in which the count permission configuration command is issued by specifying the address of the block B of the data storing flash memory 4 has been described in the above description, the present invention is not limited to this example. When the count permission configuration command is issued by specifying the addresses of the count permission flag regions A_A and A_B in the management status flash memory, for example, it may not be treated as an error and the count permission flag may be changed. This is because it is still possible to prevent tampering with the number of erasures (count value) as long as the error is issued when the addresses of the flag region F and the counter C are specified.

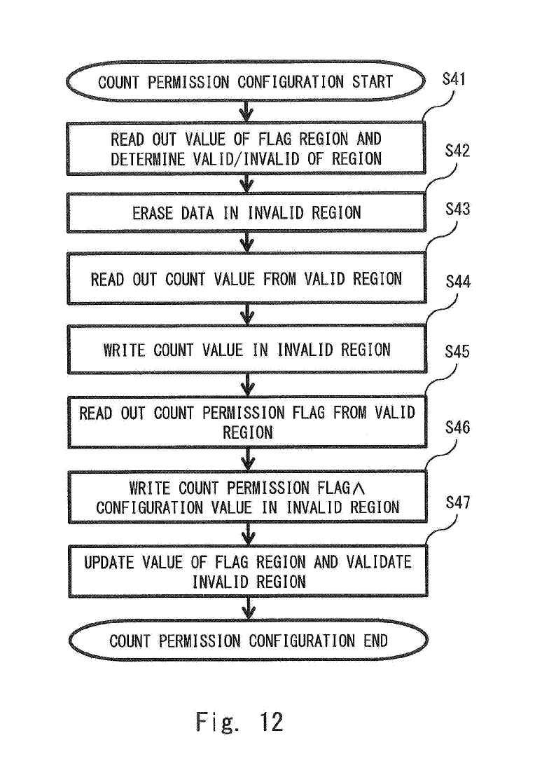

Referring next to FIG. 12, count permission configuration processing of the flash sequencer 6 according to the third embodiment will be described.

When the write data indicating the count permission configuration command has been received by the command reception unit 12, the controller 10 of the flash sequencer 6 reads out the value of the flag region F of the management status region M corresponding to the block B that configures permission of the count of the number of times that the data is erased. This block B is a block B positioned in the address indicated by the address data received by the address reception unit 11. The controller 10 determines which one of the A region M_A and the B region M_B is the valid region and which one of them is the invalid region based on the value that has been read out (S41).

The controller 10 erases the data in the invalid region and enables a new count permission flag to be written (S42). The controller 10 reads out the current count value stored in the valid region in the management status region M corresponding to the block B that configures permission of the count of the number of times that the data is erased (S43). The controller 10 directly writes the count value that has been read out into the invalid region (S44). The controller 10 reads out the current count permission flag stored in the valid region in the management status region M corresponding to the block B that sets the permission of the count of the number of times that the data is erased (S45). The controller 10 writes the value which is the result of the logical AND operation (AND operation) between the current count permission flag that has been read out and the configuration value stored in the command specifying register 22 in the count permission configuration command in the invalid region as a new count permission flag (S46). The controller 10 updates the value of the flag region F to indicate the region that stores the new count permission flag as the valid region and the other region as the invalid region (S47).

### Characteristics and Effects of Third Embodiment

As described above, in the third embodiment, the count value of the counter C corresponding to the count permission flag region A that stores the count permission flag (permission information) indicating the count permission is updated and the update of the count value of the counter C corresponding to the count permission flag region A that stores the count permission flag indicating prohibition is suppressed.

According to the above configuration, since the count value is not updated in the counter C where the count is prohibited, it is possible to reduce the time for data erasure processing. When it is sufficient, for example, to detect tampering with data in only the region that stores data that is important to ensure the security, it is possible to reduce time to erase the data in the data storing flash memory 4 and to improve the throughput when data is updated. For example, only the count by the counter C corresponding to the block B that stores important software such as a boot loader among the software stored in the data storing flash memory 4 can be permitted.

Further, in the third embodiment, when the count permission flag is changed, for the count value, the count value acquired from one of the A region M_A and the B region M_B which is indicated as valid by the value of the flag region F is directly stored in the other region. According to the above configuration, even when the permission state of the count by the counter C corresponding to one block B is changed, the count value is not changed, whereby the count value can be protected, similar to the first embodiment.

Further, in the third embodiment, the count permission flag after changes is stored in one of the A region M_A and the B region M_B which is not indicated as valid by the value of the flag region F, and the value of the flag region F is updated to indicate the region as valid. That is, the process flow according to the count permission configuration command is similar to the process flow of the management status flash memory 5 in the data erasure. Therefore, as described above with reference to FIG. 6, even when the malicious third party interrupts the count permission configuration processing of the flash sequencer 6 by means of reset or power supply off/on of the microcontroller 1, he/she cannot tamper with the count permission flag.

Further, in the third embodiment, the count permission flag is allowed to be changed when changes of the count permission flag from prohibition to permission are requested by the count permission configuration command received from the CPU 2 and the changes in the count permission flag are suppressed when changes of the count permission flag from permission to prohibition are requested. More specifically, the result of the logical AND operation between the count permission flag read out from the valid region and the new configuration value specified by the count permission configuration command is written into the invalid region as a new count permission flag.

According to this configuration, it is possible to prevent changes to prohibit the count of the number of erasures (count value). It is therefore possible to prevent the malicious third party from prohibiting the count of the number of erasures to hide unauthorized tampering with data in the data storing flash memory 4.

While the case in which both the counter C and the count permission flag region A are included in one management status region M has been described in the above description, the counter C and the count permission flag region A may be included in the management status regions M different from each other.

Further, while the embodiment in which the count permission configuration function is added to the first embodiment has been described in the above description, an embodiment in which the count permission configuration function is added to the second embodiment can be naturally executed. In this case, the management status flash memory 5 may include one management status region M, the A region M_A may include the counters C0_A to CN_A and the count permission flags A0_A to AN_A, and the B region M_B may include the counters C0_B to CN_B and the count permission flags A0_B to AN_B. Further, the management status flash memory 5 may include two management status regions M. In this case, one management status region M may have the configuration shown in FIG. 7 and the other management status region M may include the count permission flags A0_A to AN_A in the A region M_A and include the count permission flags A0_B to AN_B in the B region M_B. That is, in the case in which the count permission configuration function is added to the second embodiment as well, the counter C and the count permission flag region A may be included in the management status regions M different from each other.

Further, while the example in which the count permission flag indicates the count prohibition when the value is “1” and indicates the count permission when the value is “0” has been described in the above description, the present invention is not limited to this example. For example, the count permission flag may indicate the count prohibition when the value is “0” and indicate the count permission when the value is “1”. In this case, in the above Step S46, the value which is the result of the logical OR operation (OR operation) between the count permission flag that has been read out and the configuration value may be a new count permission flag.

### Varied Example of Third Embodiment

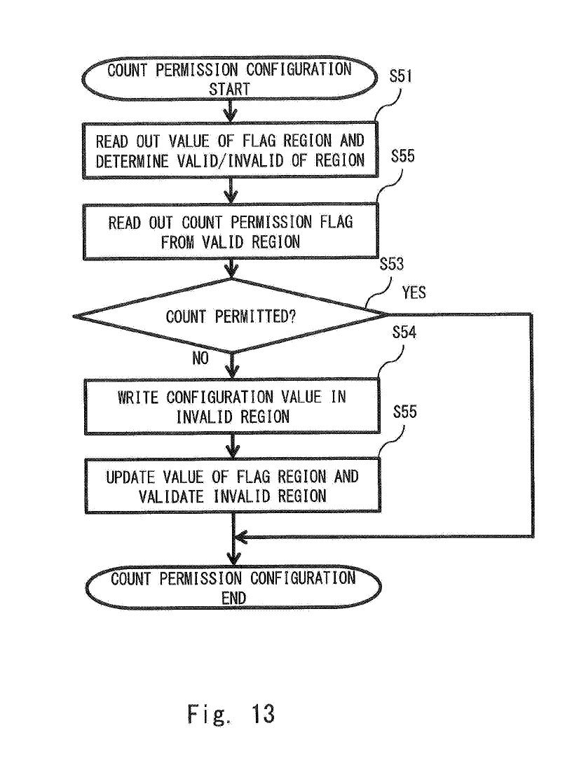

In the flash memory, when data is erased, all the bits are typically initialized to “1” and an arbitrary bit is changed from “1” to “0” by data writing. In the third embodiment, the changes of the count permission flag from the count prohibition to the count permission are allowed. Therefore, when the count permission flag indicates the count prohibition with the value of “1” and indicates the count permission with the value of “0” and the counter C and the count permission flag region A are set to be included in the management status regions M different from each other (that is, different blocks), it is possible to change the count permission flag without erasing data. Accordingly, in this case, the count permission configuration processing may be executed, as will be described next with reference to FIG. 13.

The controller 10 of the flash sequencer 6 determines whether the A region M_A and the B region M_B are valid or invalid, similar to Steps S41 and S45 to read out the current count permission flag stored in the valid region (S51 and S55). The controller 10 determines whether the count permission flag that has been read out indicates the count permission (S53).

When the count permission flag indicates the count prohibition (S53: No), the controller 10 writes the configuration value stored in the command specifying register 22 in the count permission configuration command in the invalid region as a new count permission flag (S54). The controller 10 updates the value of the flag region F, similar to Step S47 (S55). When the count permission flag indicates the count permission (S53: Yes), the controller 10 does not execute the processing of Steps S54 and S55.

According to the above processing, there is no need to erase data in the count permission configuration processing, whereby the time for the count permission configuration processing can be reduced.

### Fourth Embodiment

Next, a fourth embodiment will be described. The descriptions of the contents similar to those of the third embodiment will be omitted as appropriate. For example, since the configurations of the microcontroller 1, the flash sequencer 6, and the data storing flash memory 4 in the fourth embodiment are similar to those of the third embodiment described with reference to FIGS. 1 to 3, the descriptions thereof will be omitted.

### Configuration of Fourth Embodiment

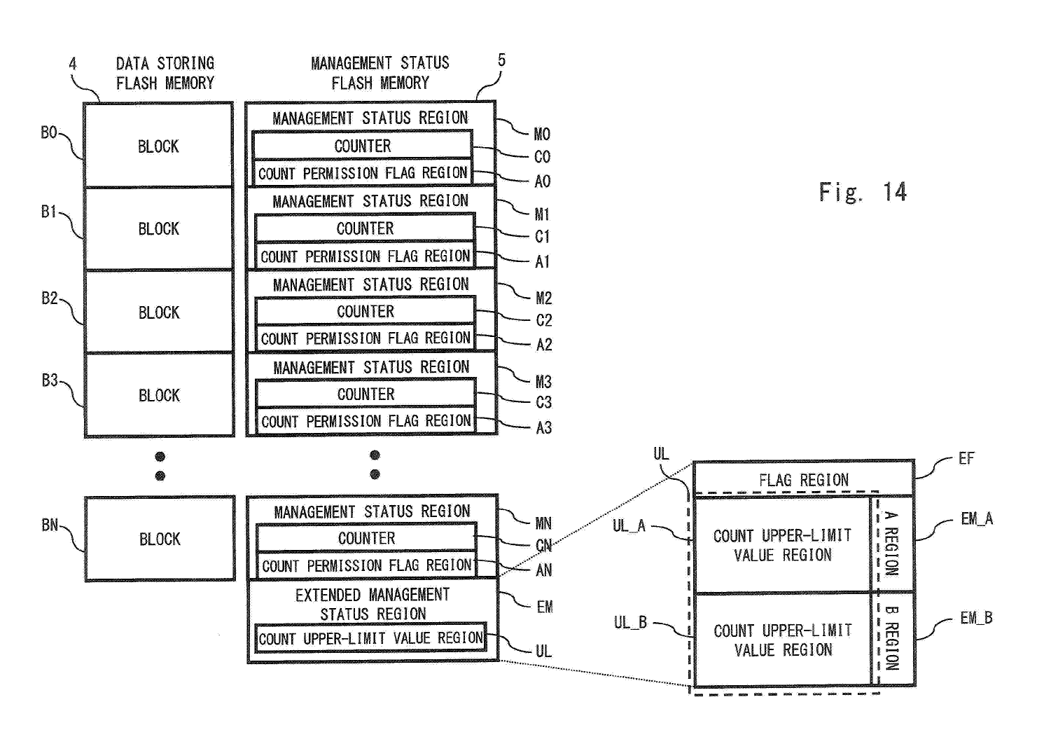

Referring next to FIG. 14, a configuration of the management status flash memory 5 according to the fourth embodiment will be described.

As shown in FIG. 14, in the fourth embodiment, the management status flash memory 5 further includes an extended management status region EM compared to the third embodiment. The extended management status region EM includes a count upper-limit value region UL. The count upper-limit value region UL stores a count upper-limit value, which is an upper-limit value of the number of times that the data is erased in the blocks B0 to BN.

More specifically, the extended management status region EM includes a flag region EF, an A region EM_A, and a B region EM_B. The flag region EF stores, similar to the flag region F described above, the value indicating which one of the A region EM_A and the B region EM_B is valid. Since the detailed contents of the flag region EF are similar to those of the flag region F, the descriptions thereof will be omitted.

The A region EM_A and the B region EM_B store a count upper-limit value region UL_A and a count upper-limit value region UL_B, respectively. That is, the count upper-limit value region UL includes the count upper-limit value region UL_A and the count upper-limit value region UL_B. Therefore, it can also be said that the value stored in the flag region EF is the value indicating which one of the count upper-limit value region UL_A and the count upper-limit value region UL_B is valid. In the A region EM_A and the B region EM_B, similar to the above A region M_A and the B region M_B, the upper-limit values are alternately updated.

More specifically, when the A region EM_A is valid, the current count upper-limit value is stored in the count upper-limit value region UL_A in the A region EM_A. In this case, when the count upper-limit value is updated, the count value of the count upper-limit value region UL_A is not updated and the value after updating the count upper-limit value is stored in the count upper-limit value region UL_B as a new current count upper-limit value. After that, the B region EM_B is made valid. On the other hand, when the B region EM_B is valid, the current count upper-limit value is stored in the count upper-limit value region UL_B in the B region EM_B. In this case, when the count upper-limit value is updated, the count upper-limit value of the count upper-limit value region UL_B is not updated and the value after updating the count upper-limit value is stored in the count upper-limit value region UL_A as the new current count upper-limit value. After that, the A region EM_A is made valid.

The flag region EF, the A region EM_A, and the B region EM_B have a size equal to or larger than the minimum unit (block) in which data is erased in the management status flash memory 5. More specifically, typically, the flag region EF, the A region EM_A, and the B region EM_B are each formed of one block different from one another. That is, the flag region EF, the A region EM_A, and the B region EM_B typically have the same size. However, when the count upper-limit value cannot be expressed by the amount of data of one block, for example, each of the A region EM_A and the B region EM_B may be formed of a plurality of blocks. While the value stored in the flag region EF can be actually expressed by the amount of data of one block, it may be formed of a plurality of blocks. Further, the value stored in the flag region EF, the value stored in the A region EM_A, and the value stored in the B region EM_B are not necessarily expressed using all the bits in the block that forms each region. Therefore, the value stored in each of the flag region EM, the value stored in the A region EM_A, and the value stored in the B region EM_B may be expressed by data having sizes different from one another.

### Operation of Fourth Embodiment

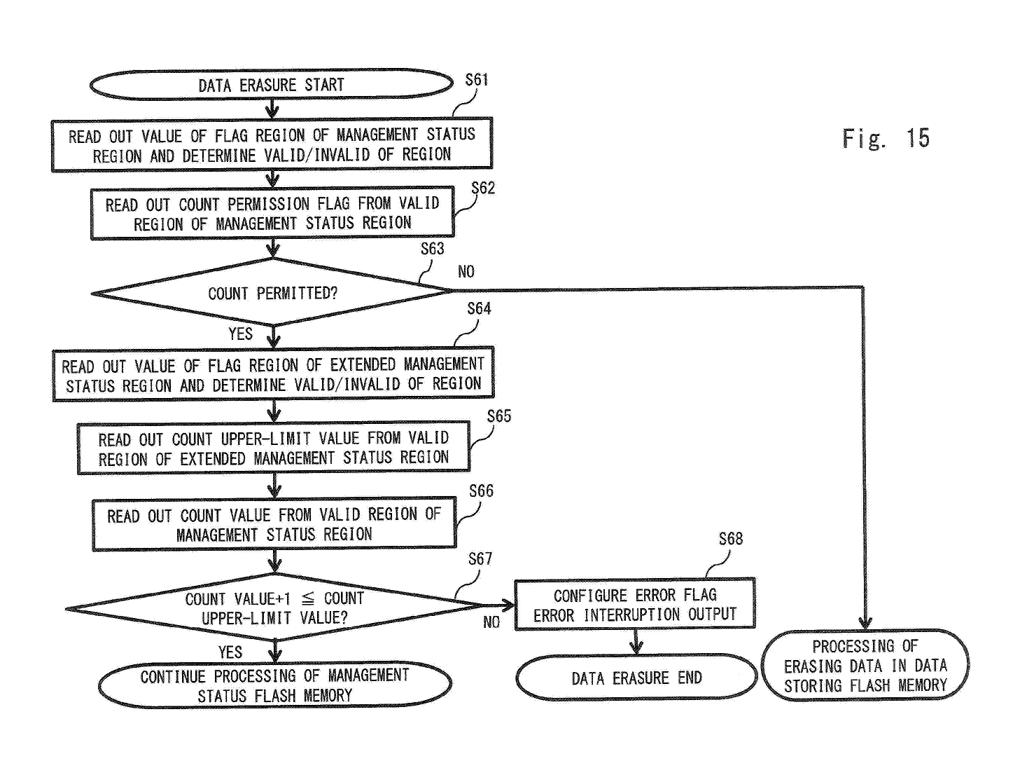

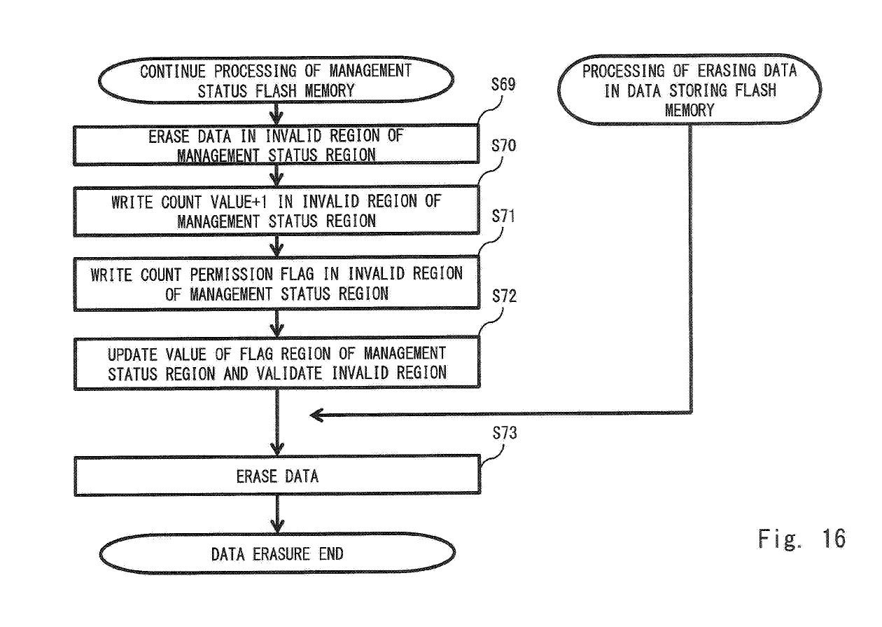

Referring next to FIGS. 15 and 16, processing for erasing data in the flash sequencer 6 according to the third embodiment will be described. Since the processing of Step S31 is similar to the processing of Step S1 according to the first embodiment, the descriptions thereof will be omitted.

The controller 10 determines whether the A region EM_A and the B region EM_B are valid or invalid, reads out the count permission flag, and determines whether the count permission flag that has been read out indicates the count permission, similar to Steps S31 to S33 in the third embodiment (S61 to S63).

When the count permission flag that has been read out indicates the count permission (S63: Yes), the controller 10 reads out the value of the flag region EF of the extended management status region EM and determines which one of the A region EM_A and the B region EM_B is the valid region and which one of them is the invalid region based on the value that has been read out (S64). The controller 10 reads out the count upper-limit value stored in the valid region in the extended management status region EM (S65). The controller 10 reads out the current count value, similar to Step S35 in the third embodiment (S66).

The controller 10 determines whether the value obtained by adding 1 to the current count value that has been read out is equal to or smaller than the count upper-limit value that has been read out (S67). When the value obtained by adding 1 to the current count value is larger than the count upper-limit value (S67: No), 1 is stored in the error flag of the status register 23, whereby the status data to report the error is output to the CPU 2 as an error interruption signal to end data erasure processing (S68). Note that the error flag indicating the error (erase count error) and the error flag indicating the count permission configuration error, the write error, and the erase error may be defined collectively in one bit or may be defined separately in bits different from each other.

When the value obtained by adding 1 to the current count value is equal to or smaller than the count upper-limit value (S67: Yes), the controller 10 deletes the data in the invalid region, writes the value obtained by adding 1 to the current count value in the invalid region, writes the count permission flag in the invalid region, updates the value of the flag region F, and erases the data in the block B, similar to Steps S34 and S36 to S39 in the third embodiment (S69 to S73). The data erasure processing is then completed.

When the count permission flag that has been read out indicates the count prohibition (S63: No), the controller 10 erases the data in the block B and ends the data erasure processing without executing the processing of Steps S64 to 72 (S73).

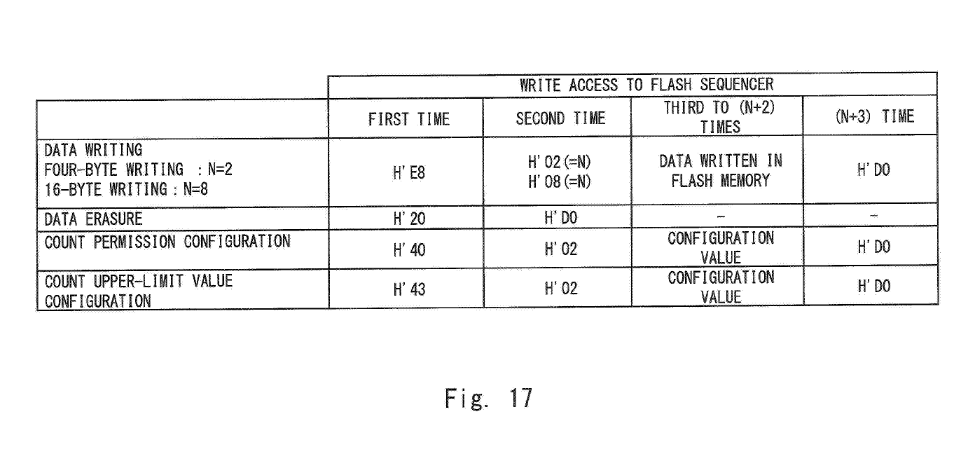

Referring next to FIG. 17, commands of the flash sequencer 6 according to the fourth embodiment will be described. In the fourth embodiment, as shown in FIG. 17, a count upper-limit value configuration command is further prepared compared to the third embodiment.

When the count upper-limit value is set, the CPU 2 sequentially writes the write data indicating the count upper-limit value configuration command into the command specifying register 22 via the peripheral bus 8. More specifically, the CPU 2 sequentially writes the write data into the command specifying register 22 in the order of H′43, H′02, the configuration value for the count upper-limit value, and H′D0.

In response to the above operation, the controller 10 of the flash sequencer 6 changes the count upper-limit value of the count upper-limit value region UL of the extended management status region EM based on the configuration value written as the write data.

Since the count upper-limit value is stored only in the extended management status region EM, the address data written into the address specifying register 21 will not be taken into consideration. However, the present invention is not limited to this example. For example, when the count upper-limit value configuration command has been issued by specifying the address of the count upper-limit value region UL in the management status flash memory 5, it may not be treated as the error and the count upper-limit value may be changed. This is because even in the above case, as long as the error is issued when the addresses of the flag region F and the counter C (A region M_A, B region M_A) are specified, it is possible to prevent tampering with the number of erasures (count value).

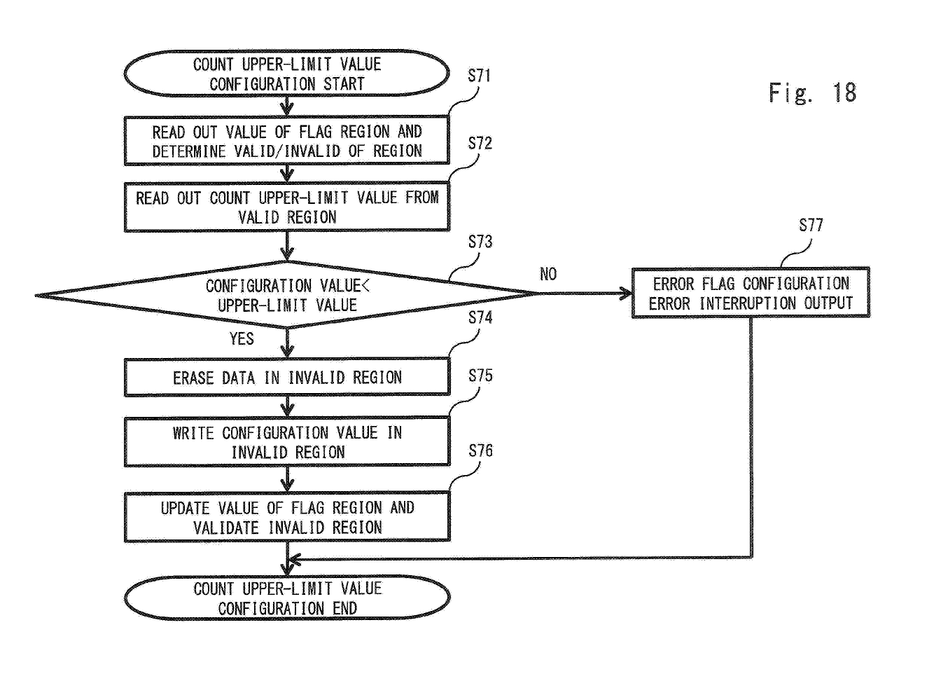

Referring next to FIG. 18, processing for configuring the count upper-limit value of the flash sequencer 6 according to the fourth embodiment will be described.

When the write data indicating the count upper-limit value configuration command has been received by the command reception unit 12, the controller 10 of the flash sequencer 6 reads out the value of the flag region EF in the extended management status region EM. The controller 10 determines which one of the A region EM_A and the B region EM_B is the valid region and which one of them is the invalid region based on the value that has been read out (S71). The controller 10 reads out the current count upper-limit value stored in the valid region in the extended management status region EM (S72). The controller 10 determines whether the configuration value stored in the command specifying register 22 in the count upper-limit value configuration command is smaller than the current count upper-limit value that has been read out (S73).

When it is determined that the configuration value is smaller than the count upper-limit value (S73: Yes), the controller 10 erases the data in the invalid region in the extended management status region EM and enables a new count upper-limit value to be written (S74). The controller 10 writes the configuration value in the invalid region as the new count upper-limit value (S75). The controller 10 indicates the region where the new count upper-limit value is stored as the valid region and updates the value of the flag region F to indicate the other region as the invalid region (S76).

When it is determined that the configuration value is equal to or larger than the count upper-limit value (S73: No), 1 is stored in the error flag of the status register 23, whereby the status data to report the error is output to the CPU 2 as the error interruption signal and count upper-limit value configuration processing is ended (S77). Note that the error flag indicating the error (count upper-limit value configuration error) and the error flag indicating the erasure count error, the count permission configuration error, the write error, and the erase error may be defined collectively in one bit or may be defined in bits different from each other.

### Characteristics and Effects of Fourth Embodiment

As described above, in the fourth embodiment, when the count value indicated by the counter C exceeds the counter upper-limit value stored in the count upper-limit value (upper-limit value storage region), data erasure in the block B is suppressed. According to this configuration, it is possible to prevent the malicious third party from repeating tampering with data in the data storing flash memory 4 and executing debug or the like of the software.

Further, in the fourth embodiment, when the count upper-limit value is changed, the count value is not changed. Therefore, it is possible to protect the count value, similar to the first and third embodiments.

Further, in the fourth embodiment, the count upper-limit value that has been changed is stored in one of the A region EM_A and the B region EM_B which is not indicated as valid by the value of the flag region F and the value of the flag region F is updated to indicate the region as valid. That is, the process flow according to the count upper-limit value configuration command is similar to the process flow of the management status flash memory in the data erasure. Therefore, as described with reference to FIG. 6, even when the malicious third party interrupts the count upper-limit value configuration processing of the flash sequencer 6 by means of reset or power supply off/on of the microcontroller 1, he/she cannot tamper with the count upper-limit value.

Further, in this fourth embodiment, when the count upper-limit value is required to be lowered by the count upper-limit value configuration command received from the CPU 2, changes of the count upper-limit value are allowed, and when the count upper-limit value is required to be increased, changes of the count upper-limit value are suppressed. According to the above configuration, it is possible to prevent the malicious third party from increasing the count upper-limit value to continue tampering with the data storing flash memory 4.

Further, while the embodiment in which the data erasure suppression function and the count upper-limit value configuration function by the count upper-limit value are added to the third embodiment has been described in the above description, an embodiment in which the data erasure suppression function and the count upper-limit value configuration function are added to the first embodiment or the second embodiment can be naturally executed as well.

Further, the count upper-limit value region UL may be included in each of the management status regions M0 to MN, similar to the counter C and the count permission flag region A. In this case, the controller 10 determines whether to allow or suppress the data erasure in the block B by determining whether the count value of the count C in the management status region M corresponding to the block B exceeds the count upper-limit value of the count upper-limit value region UL.

While the present invention made by the inventors has been specifically described above, it is needless to say that the present invention is not limited to the embodiments already stated above and may be changed in various ways without departing from the spirit of the present invention.

While the example of the microcontroller 1 has been described in the first to fourth embodiments, it is not limited to this example. The information processing apparatus including the above flash memories 4 and 5 and the flash sequencer 6 is not limited to a microcontroller and may be a personal computer or the like. However, when the personal computer or the like is used, the flash memories 4 and 5 and the flash sequencer 6 are preferably included in one chip. According to this configuration, by connecting the flash memories 4 and 5 to other devices without the intervention of the flash sequencer 6, it is possible to prevent unauthorized tampering with data in the flash memories 4 and 5.

In the above first to fourth embodiments, the example in which the region that stores the data (block B) and the region that stores the count value indicating the number of times that the data is erased (counter C) are included in the flash memories 4 and 5 different from each other has been described. However, the present invention is not limited to this example. That is, the block B and the management status region M (counter C) may be included in one flash memory. This is because even in the above case, as long as the data write and data erasure of the data that specifies the address of the management status region M (counter C) are suppressed, it is possible to prevent tampering with the number of erasures (count value).

However, as stated above, in many cases, all or most of the blocks (minimum erasure unit of data) of the flash memory have the same size. On the other hand, the data (value of the flag region F, the count value) in the management status region M is smaller in size than that of the data (e.g., software) in the block B. Therefore, by storing these pieces of data in one flash memory, when the data in the management status region M is stored in a block having the size same as that of the block B, a wasted region that is not substantially used is generated in the flash memory. Therefore, as described in the first to fourth embodiments, the block B and the management status region M (counter C) may be preferably included in the flash memories different from each other. According to this configuration, by employing the flash memory smaller in the block size than that of the data storing flash memory 4 as the management status flash memory 5, it is possible to eliminate the above waste and to reduce the whole capacity of the flash memory. Further, since it is possible to reduce the block size, the data erasure and the data write time when the count value or the like is updated can be reduced.

For example, the microcontroller may include both a code flash memory having a large block size (program storing flash memory) and a data flash memory having a block size smaller than that of the code flash memory (data storing flash memory) mounted thereto. In such a case, the data flash memory can be efficiently used as the management status flash memory 4.

Further, in the above first to fourth embodiments, the example in which the management status region M includes the A region M_A and the B region M_B, the counter C_A and the count permission flag region A_A are included in the A region M_A, and the counter C_B and the count permission flag region A_B are included in the B region M_B has been described above. However, the present invention is not limited to this example. The management status region M may include one counter and one count permission flag region. However, by alternately updating the data in the A region M_A and the data in the B region M_B as stated above, it is possible to prevent unauthorized tampering with data as described with reference to FIG. 6.

Further, while the count permission flag can be changed in the above third embodiment, a predetermined fixed value may be included as the count permission flag. While the count upper-limit value can be varied in the above fourth embodiment as well, the count upper-limit value may be a predetermined fixed value.

Further, while the example in which the counter C indicates the number of erasures as the count value has been described in the first to fourth embodiments, the present invention is not limited to this example. For example, the counter C may indicate a value obtained by multiplying the number of erasures by a predetermined value as the count value. That is, in this case, the controller 10 adds a predetermined value to the count value to update the count value of the counter C.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

The first to forth embodiments can be combined as desirable by one of ordinary skill in the art.

What is claimed is:

1. An information processing apparatus comprising:
at least one flash memory comprising a data storage region that stores data and an erase count storage region that stores erase count data indicating the number of times that the data is erased in the data storage region; and
a control circuit that is connected between a processor and the at least one flash memory,
wherein the control circuit allows changes of the data stored in the data storage region by the processor and suppresses changes of the erase count data stored in the erase count storage region by the processor.

2. The information processing apparatus according to claim 1, wherein the control circuit erases data stored in the data storage region after erase count data stored in the erase count storage region is updated.

3. The information processing apparatus according to claim 1, wherein:
the erase count storage region comprises a first erase count storage region and a second erase count storage region that store the erase count data,
the at least one flash memory comprises a region information storage region that stores region information indicating which one of the first erase count storage region and the second erase count storage region is valid, and
the control circuit acquires, when data in the data storage region is erased, the erase count data from one of the first erase count storage region and the second erase count storage region which is indicated as valid by the region information, updates the erase count data that has been acquired to store the erase count data that has been updated in the other erase count storage region, and updates the region information to indicate the other erase count storage region as valid.

4. The information processing apparatus according to claim 3, wherein:
the at least one flash memory comprises a plurality of data storage regions, a plurality of first erase count storage regions, and a plurality of second erase count storage regions, and
the control circuit acquires, for the erase count storage region corresponding to the data storage region in which the data is erased, the erase count data from the erase count storage region indicated as valid by the region information, updates the erase count data that has been acquired to store the erase count data that has been updated in the other erase count storage region, and for the other erase count storage regions, directly stores the erase count data acquired from the erase count storage region indicated as valid by the region information in the other erase count storage region.

5. The information processing apparatus according to claim 1, wherein:
the at least one flash memory comprises a plurality of data storage regions,
the at least one flash memory further comprises a plurality of erase count storage regions and a plurality of permission information storage regions that store permission information indicating permission/prohibition of the update of the erase count data, the plurality of erase count storage regions and the plurality of permission information storage regions corresponding to the plurality of respective data storage regions, and
the control circuit updates the erase count data for the erase count storage region corresponding to the permission information storage region that stores permission information indicating permission and suppresses update of the erase count data for the erase count storage region corresponding to the permission information storage region that stores the permission information indicating prohibition.

6. The information processing apparatus according to claim 5, wherein
the processor transmits change request data to request a change in the permission information to the control circuit, and
the control circuit allows changes of the permission information when changes of the permission information from prohibition to permission have been requested by the change request data received from the processor and suppresses changes of the permission information when changes of the permission information from permission to prohibition have been requested by the change request data received from the processor.

7. The information processing apparatus according to claim 6, wherein:
the permission information storage region comprises a first permission information storage region and a second permission information storage region that store the permission information,
the at least one flash memory further comprises a region information storage region that stores region information indicating which one of the first permission information storage region and the second permission information storage region is valid, and
when the permission information is changed, the control circuit stores the permission information after the change in one of the first permission information storage region and the second permission information storage region that is not indicated as valid by the region information and updates the region information to indicate the permission information storage region as valid.

8. The information processing apparatus according to claim 1, wherein:
the at least one flash memory further comprises an upper-limit value storage region that stores an upper-limit value of the number of erasures, and
the control circuit suppresses data erasure in the data storage region when the number of erasures indicated by the erase count data exceeds the upper-limit value stored in the upper-limit value storage region.

9. The information processing apparatus according to claim 8, wherein:
the processor transmits upper-limit value change request data that requests changes in the upper-limit value to the control circuit, and
the control circuit allows changes of the upper-limit value when changes to decrease the upper-limit value have been requested by the upper-limit value change request data received from the processor and suppresses changes of the upper-limit value when changes to increase the upper-limit value have been requested.

10. The information processing apparatus according to claim 9, wherein:
the upper-limit value storage region comprises a first upper-limit value storage region and a second upper-limit value storage region that store the upper-limit value,
the at least one flash memory further comprises a region information storage region that stores region information indicating which one of the first upper-limit value storage region and the second upper-limit value storage region is valid, and
the control circuit stores, when the upper-limit value is changed, an upper-limit value after the change in one of the first upper-limit value storage region and the second upper-limit value storage region that is not indicated as valid by the region information and updates the region information to indicate the upper-limit value storage region as valid.

11. The information processing apparatus according to claim 1, wherein:
the at least one flash memory comprises a first flash memory including a first block including the data storage region and a second flash memory including a second block including the erase count storage region, and
the second block is a data erasure unit having a size smaller than that of the first block.

12. A flash memory control method comprising:
receiving from a processor a data change request for at least one flash memory, the flash memory comprising a data storage region that stores data and an erase count storage region that stores erase count data indicating the number of times that the data is erased in the data storage region, and
changing the data when the data storage region is specified by the data change request as a target to be changed and not changing the erase count data when the erase count storage region is specified by the data change request as the target to be changed.
